(19) United States
(12) Patent Application Publication
(10) Pub. No.: US 2026/0146674 A1
(43) Pub. Date: May 28, 2026

(54) VALVE SEATS FOR ENHANCING PRECISION CONTROL IN PNEUMATIC VALVES

(71) Applicant: Aventics GMBH, Laatzen (DE)

(72) Inventors: Carsten Ammann, Burgdorf (DE); Andreas Busch, Quedlinburg (DE)

(21) Appl. No.: 19/121,297

(22) PCT Filed: Oct. 20, 2022
(86) PCT No.: PCT/EP2022/079295

§ 371 Date: Apr. 15, 2025

(51) Int. Cl. F16K 1/54; F16K 1/42; F16K 25/00; F16K 31/06

(52) U.S. Cl. CPC F16K 1/54; F16K 1/42; F16K 25/005; F16K 31/0655

(57) ABSTRACT

Example valve seats for enhancing pressure control in pneumatic valves are disclosed. An example valve seat for use with a pneumatic valve includes a central axis and a sealing surface. The sealing surface includes a plurality of indentations extending in an axial direction defined by the central axis.

### FIELD OF THE DISCLOSURE

This disclosure relates generally to pneumatic valves and, more specifically, to valve seats for enhancing precision control in pneumatic valves.

### BACKGROUND

Pneumatic valves are commonly used to control the pressure, rate, and volume of air moving through a pneumatic system. In some known pneumatic valve implementations, the flow of pressurized air from an inlet port of a cartridge of the pneumatic valve to an outlet port of the cartridge of the pneumatic valve is determined based on the position of a plunger of the cartridge relative to a valve seat of the cartridge, with the position of the plunger being controlled via a proportional solenoid of the cartridge. It is desirable to achieve and maintain precision control (e.g., high-precision pressure control) over the operation of a pneumatic valve.

### SUMMARY

Valve seats for enhancing precision control in pneumatic valves are disclosed herein. In some examples, a valve seat for use with a pneumatic valve is disclosed. In some disclosed examples, the valve seat comprises a central axis and a sealing surface. In some disclosed examples, the sealing surface includes a plurality of indentations extending in an axial direction defined by the central axis.

In some examples, a pneumatic valve cartridge is disclosed. In some disclosed examples, the pneumatic valve cartridge comprises a valve seat including a central axis and a sealing surface. In some disclosed examples, the sealing surface includes a plurality of indentations extending in an axial direction defined by the central axis. In some disclosed examples, the pneumatic valve cartridge further comprises a plunger movable relative to the valve seat along the central axis between a fully-closed position and a fully-open position. In some disclosed examples, the pneumatic valve cartridge further comprises a sealing member coupled to the plunger. In some disclosed examples, the sealing member is configured to form an air-tight seal with the sealing surface when the plunger is in the fully-closed position. In some disclosed examples, the pneumatic valve cartridge further comprises a proportional solenoid configured to move the plunger relative to the valve seat.

### BRIEF DESCRIPTION OF THE DRAWINGS

FIG. 1 is a cross-sectional view of a known pneumatic valve cartridge.

FIG. 2 is a cross-sectional view illustrating the plunger of FIG. 1 in a fully-closed position relative to the valve seat of FIG. 1.

FIG. 3 is a cross-sectional view illustrating the plunger of FIGS. 1 and 2 in a fully-open position relative to the valve seat of FIGS. 1 and 2.

FIG. 4 is a perspective view of the valve seat of FIGS. 1-3.

FIG. 5 is a bottom view of the valve seat of FIGS. 1-4.

FIG. 6 is a cross-sectional view of the valve seat of FIGS. 1-5 taken along section A-A of FIG. 5.

FIG. 7 is an enlarged view of a portion of FIG. 6.

FIG. 8 is a rotated view of the portion of FIG. 6 shown in FIG. 7.

FIG. 9 is a cross-sectional view illustrating the plunger of FIG. 1-3 in a partially-open position relative to the valve seat of FIGS. 1-8.

FIG. 10 is an enlarged view of a portion of FIG. 9.

FIG. 11 is a graph including pressure data associated with operation of the pneumatic valve cartridge of FIG. 1 when implementing the valve seat of FIGS. 1-10.

FIG. 12 is a perspective view of an example valve seat constructed in accordance with the teachings of this disclosure and configured for use with the pneumatic valve cartridge of FIG. 1.

FIG. 13 is a bottom view of the valve seat of FIG. 12.

FIG. 14 is a cross-sectional view of the valve seat of FIGS. 12 and 13 taken along section B-B of FIG. 13.

FIG. 15 is an enlarged view of a portion of FIG. 14.

FIG. 16 is a rotated view of the portion of FIG. 14 shown in FIG. 15.

FIG. 17 is a cross-sectional view illustrating the plunger of FIGS. 1-3, 9, and 10 in a partially-open position relative to the valve seat of FIGS. 12-16.

FIG. 18 is an enlarged view of a portion of FIG. 17.

FIG. 19 is a graph including pressure data associated with operation of the pneumatic valve cartridge of FIG. 1 when implementing the valve seat of FIGS. 12-18 in lieu of the valve seat of FIGS. 1-10.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

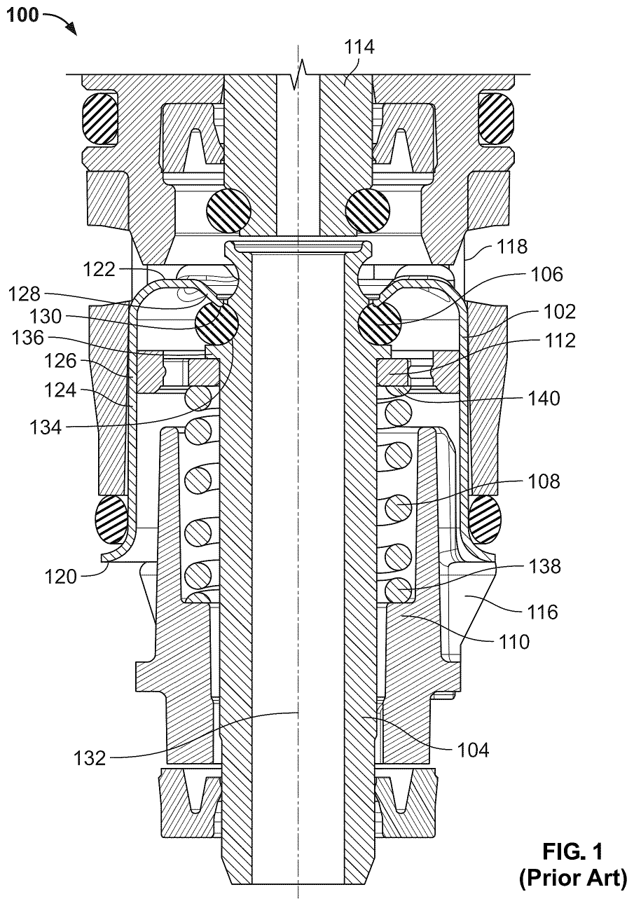

It is desirable to achieve and maintain precision control (e.g., high-precision pressure control) over the operation of a pneumatic valve. High-precision geometries (e.g., perfectly circular, perfectly annular, etc.) of the sealing surfaces of valve seats of known pneumatic valves can lead to a persistent presence of oscillations in the controlled pressure of such pneumatic valves following a sudden increase in a setpoint pressure associated with such pneumatic valves. The persistence of such oscillations demonstrates an undesired instability relative to the process of controlling the pressure of the pneumatic valve, thereby reducing the ability for high-precision control (e.g., granular and/or fine control) of the airflow characteristics (e.g., pressure, rate, and/or volume) of the pneumatic valve. An example of such a known pneumatic valve and the control operations thereof is described below in connection with FIGS. 1-11.

FIG. 1 is a cross-sectional view of a known pneumatic valve cartridge 100. The pneumatic valve cartridge 100 of FIG. 1 includes a valve seat 102, a plunger 104, a sealing member 106, a spring 108, a spring seat 110, a spring retainer 112, a proportional solenoid 114, an inlet port 116, and an outlet port 118.

The valve seat 102 of FIG. 1 is a deep-drawn, metallic (e.g., stainless steel) component of the pneumatic valve cartridge 100. The valve seat 102 includes a first end 120 (e.g., a lower end) and a second end 122 (e.g., an upper end) located opposite the first end 120 of the valve seat 102. The valve seat 102 is configured to circumscribe the plunger 104 of the pneumatic valve cartridge 100. In this regard, the valve seat 102 includes an annular sidewall 124 having an outer portion 126 extending from the first end 120 of the valve seat 102 to the second end 122 of the valve seat 102, and an inner portion 128 located radially inward from the outer portion 126 and extending downwardly from the second end 122 (e.g., the upper end) of the valve seat 102 toward the first end 120 of the valve seat 102. The inner portion 128 of the annular sidewall 124 of the valve seat 102 includes an annular rim that forms a sealing surface 130 located between the first end 120 and the second end 122 of the valve seat 102. The sealing surface 130 of the valve seat 102 is configured to contact and/or mate with the sealing member 106 of the pneumatic valve cartridge 100 when the plunger 104 of the pneumatic valve cartridge 100 is in a closed position relative to the valve seat 102, as further described below.

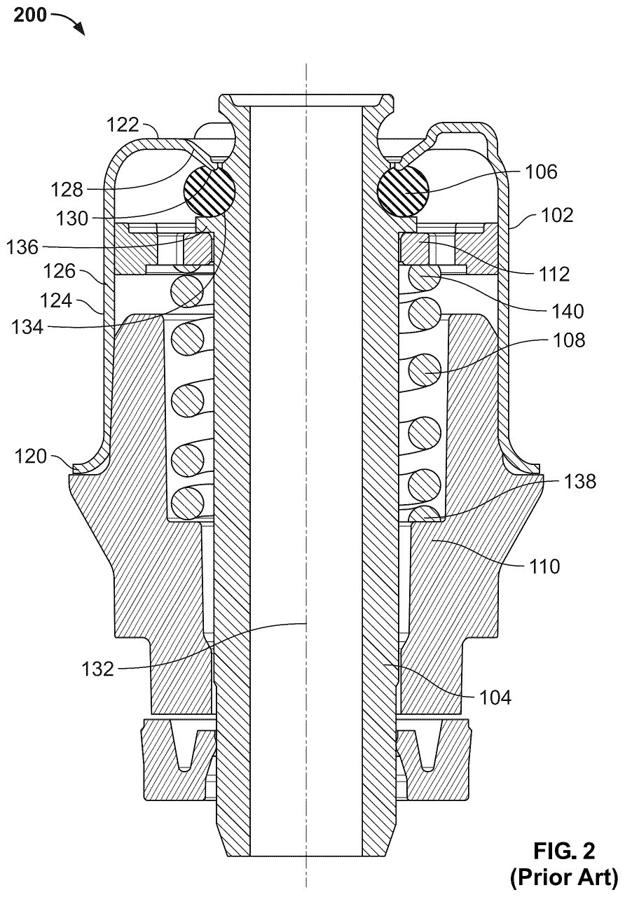

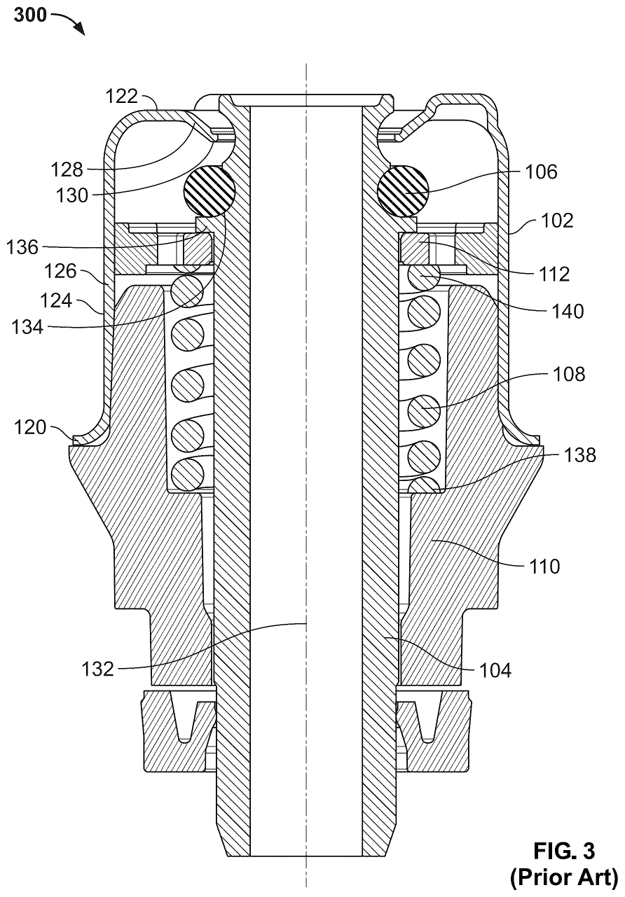

The plunger 104 of FIG. 1 is movable (e.g., slidable) relative to the valve seat 102 along a central axis 132 of the valve seat 102 (more generally, a central axis 132 of the pneumatic valve cartridge 100) between a closed position (e.g., a fully-closed position) and an open position (e.g., a fully-open position). For example, FIG. 2 is a cross-sectional view illustrating the plunger 104 of FIG. 1 in a fully-closed position 200 relative to the valve seat 102 of FIG. 1. By contrast, FIG. 3 is a cross-sectional view illustrating the plunger 104 of FIGS. 1 and 2 in a fully-open position 300 relative to the valve seat 102 of FIGS. 1 and 2. The plunger 104 includes a notch 134 configured to receive a portion of the sealing member 106 of the pneumatic valve cartridge 100 such that the sealing member 106 is coupled to and/or moves along with the plunger 104. The plunger 104 further includes a flange 136 configured to contact the spring retainer 112 of the pneumatic valve cartridge 100 such that the spring retainer 112 and the plunger 104 move together.

The sealing member 106 of FIG. 1 is an elastomeric structure (e.g., an O-ring) configured to provide and/or maintain a seal (e.g., an air-tight seal) between the plunger 104 of the pneumatic valve cartridge 100 and the valve seat 102 of the pneumatic valve cartridge 100 when the plunger 104 is in the fully-closed position 200 relative to the valve seat 102. As shown in FIG. 1, a portion of the sealing member 106 is received by and/or located within the notch 134 of the plunger 104 of the pneumatic valve cartridge 100. In this regard, the sealing member 106 has an annular shape, with the sealing member 106 being configured to circumscribe the plunger 104 of the pneumatic valve cartridge 100 proximate the notch 134 formed in the plunger 104. In other examples, the sealing member 106 can instead have a different form and/or composition (e.g., vulcanized rubber), and/or can be coupled to the plunger 104 in a different way.

The spring 108 of FIG. 1 includes a first end 138 (e.g., a lower end) positioned against the spring seat 110 of the pneumatic valve cartridge 100, and a second end 140 (e.g., an upper end) located opposite the first end 138 of the spring 108 and positioned against the spring retainer 112 of the pneumatic valve cartridge 100. The spring retainer 112 of the pneumatic valve cartridge 100 is accordingly located between the second end 140 of the spring 108 and the flange 136 of the plunger 104. As shown in FIGS. 1-3, the spring 108 is configured to circumscribe the plunger 104. The spring 108 is further configured to bias the spring retainer 112 along the central axis 132 of the pneumatic valve cartridge 100 in a direction away from the spring seat 110 of the pneumatic valve cartridge 100 and/or toward the proportional solenoid 114 of the pneumatic valve cartridge 100, thereby biasing the plunger 104 of the pneumatic valve cartridge 100 into the fully-closed position 200 relative to the valve seat 102 of the pneumatic valve cartridge 100.

The proportional solenoid 114 of FIG. 1 is operatively coupled to (e.g., in electrical communication with) a control system of the pneumatic valve cartridge 100, with the control system being configured to selectively supply an electrical current to the proportional solenoid 114 to regulate and/or control the force provided by the proportional solenoid 114 against the plunger 104 of the pneumatic valve cartridge 100. The force provided by the proportional solenoid 114 counteracts the above-described biasing force provided by the spring 108 of the pneumatic valve cartridge 100. Regulating and/or controlling the force provided by the proportional solenoid 114 against the plunger 104 directly regulates and/or directly controls the position of the plunger 104 relative to the valve seat 102, which in turn directly regulates and/or directly controls the pressure, the flow rate, and the volume of air exiting the outlet port 118 of the pneumatic valve cartridge 100.

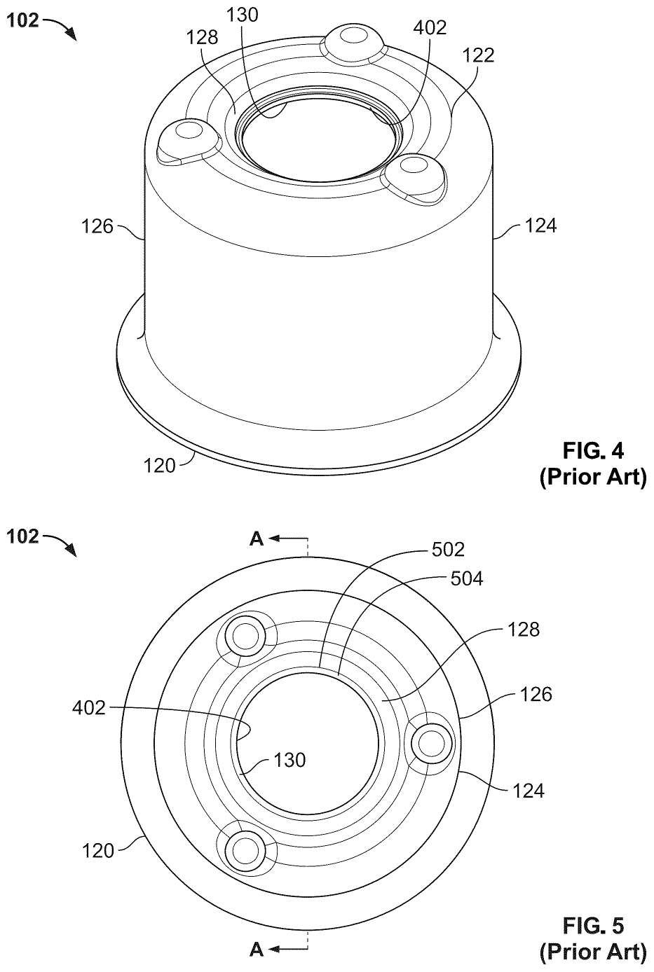

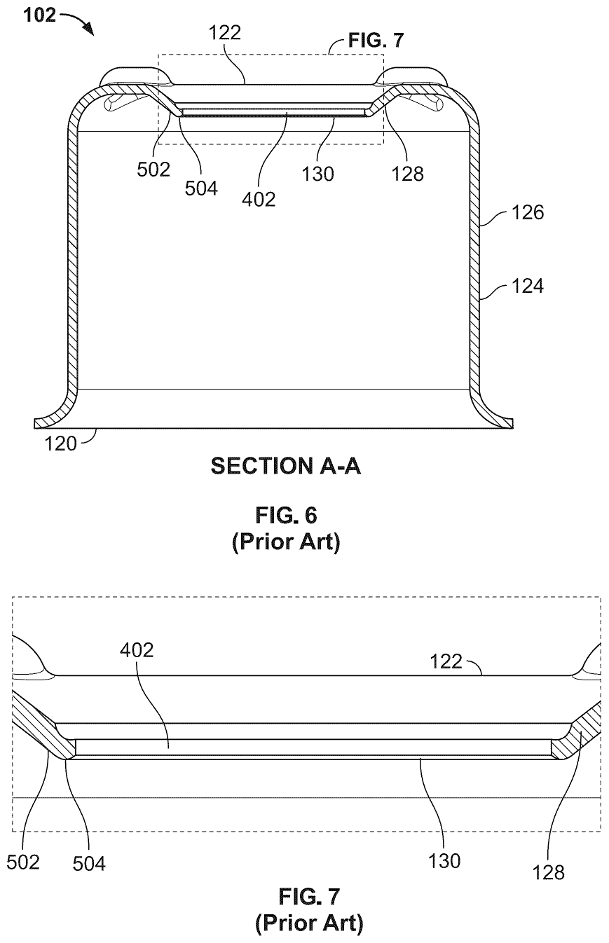

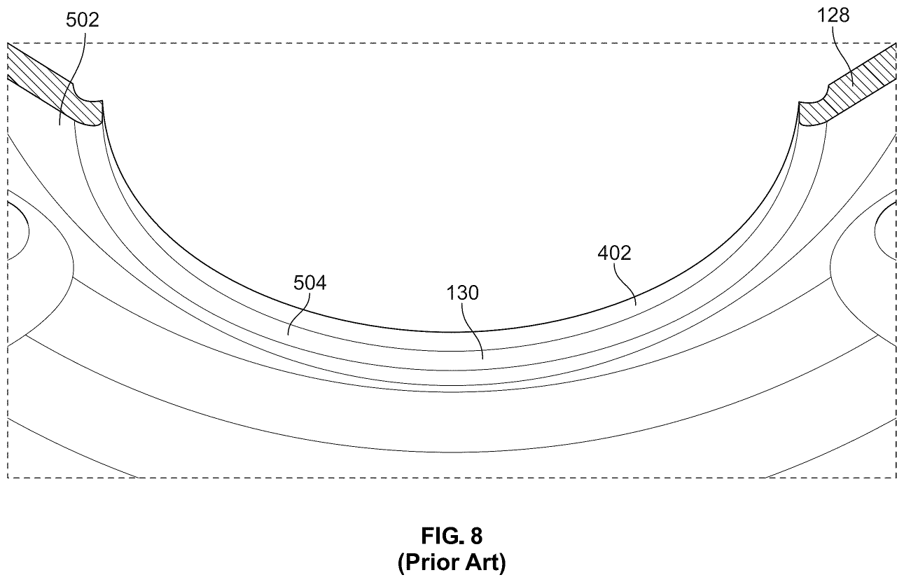

FIGS. 4-8 illustrate the valve seat 102 of the pneumatic valve cartridge 100 in greater detail. FIG. 4 is a perspective view of the valve seat 102 of FIGS. 1-3. FIG. 5 is a bottom view of the valve seat 102 of FIGS. 1-4. FIG. 6 is a cross-sectional view of the valve seat 102 of FIGS. 1-5 taken along section A-A of FIG. 5. FIG. 7 is an enlarged view of a portion of FIG. 6. FIG. 8 is a rotated view of the portion of FIG. 6 shown in FIG. 7.

As discussed above in connection with FIG. 1, the inner portion 128 of the annular sidewall 124 of the valve seat 102 includes an annular rim that forms the sealing surface 130 of the valve seat 102. The sealing surface 130 includes an inner surface 402 and an outer surface 502 located opposite the inner surface 402. The sealing surface 130 further includes an interface surface 504 extending between the inner surface 402 and the outer surface 502, with the interface surface 504 being configured to contact and/or engage the sealing member 106 when the plunger 104 of the pneumatic valve cartridge 100 is in the fully-closed position 200 relative to the valve seat 102 of the pneumatic valve cartridge 100. The valve seat 102 is a high-precision component manufactured according to dimensional specifications having very low tolerance ranges. As a result, the valve seat 102 and, more specifically, the interface surface 504 of the sealing surface 130 of the valve seat 102 has minimal unintended defects and/or unintended deformations. In this regard, the interface surface 504 of the sealing surface 130 is perfectly circular and/or perfectly annular except for any unintended defects and/or unintended deformations that may be present by virtue of the chosen manufacturing process. When the plunger 104 of the pneumatic valve cartridge 100 is in the fully-closed position 200 relative to the valve seat 102 of the pneumatic valve cartridge 100, the aforementioned high-precision geometry of the sealing surface 130 of the valve seat 102 facilitates the formation of a reliable, air-tight seal between the interface surface 504 of the sealing surface 130 of the valve seat 102 and the sealing member 106 that is coupled to the plunger 104.

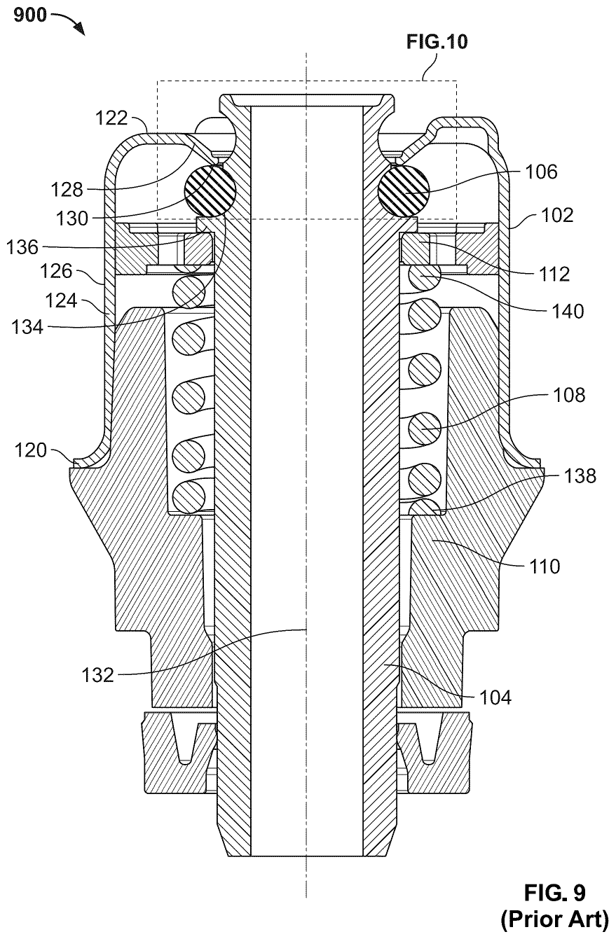

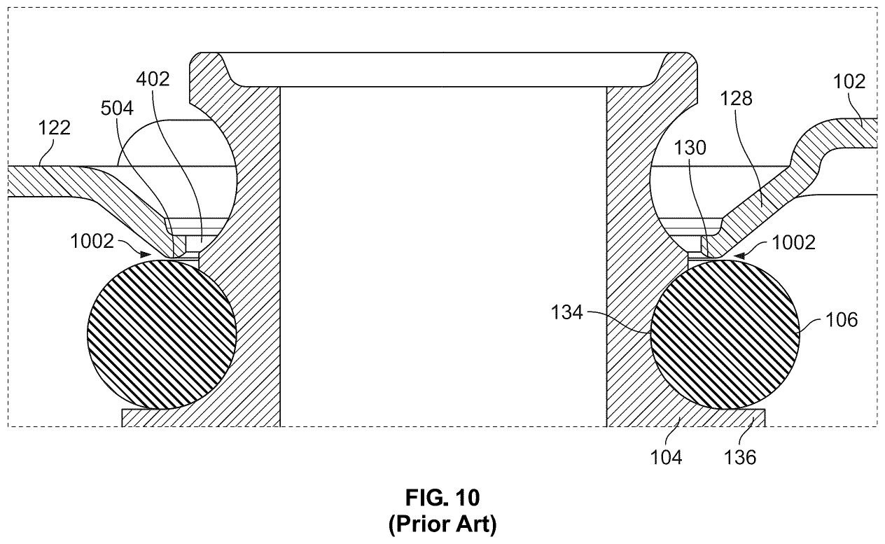

FIG. 9 is a cross-sectional view illustrating the plunger 104 of FIG. 1-3 in a partially-open position 900 relative to the valve seat 102 of FIGS. 1-8. FIG. 10 is an enlarged view of a portion of FIG. 9. As the plunger 104 of the pneumatic valve cartridge 100 moves from the fully-closed position 200 shown in FIG. 2 into the partially-open position 900 shown in FIGS. 9 and 10, the high-precision geometry of interface surface 504 of the sealing surface 130 of the valve seat 102 causes the sudden opening of a relatively large, perfectly-annular airflow area 1002 located between the interface surface 504 of the sealing surface 130 of the valve seat 102 of the pneumatic valve cartridge 100 and the sealing member 106 of the pneumatic valve cartridge 100. As a result of the sudden opening of the airflow area 1002, the pressure, rate, and/or volume of air flowing to and/or exiting the outlet port 118 of the pneumatic valve cartridge 100 increases in a correspondingly sudden and/or rapid manner, thereby making high-precision control (e.g., granular and/or fine control) of the airflow characteristics (e.g., pressure, rate, and/or volume) of the pneumatic valve cartridge 100 difficult to achieve and/or maintain.

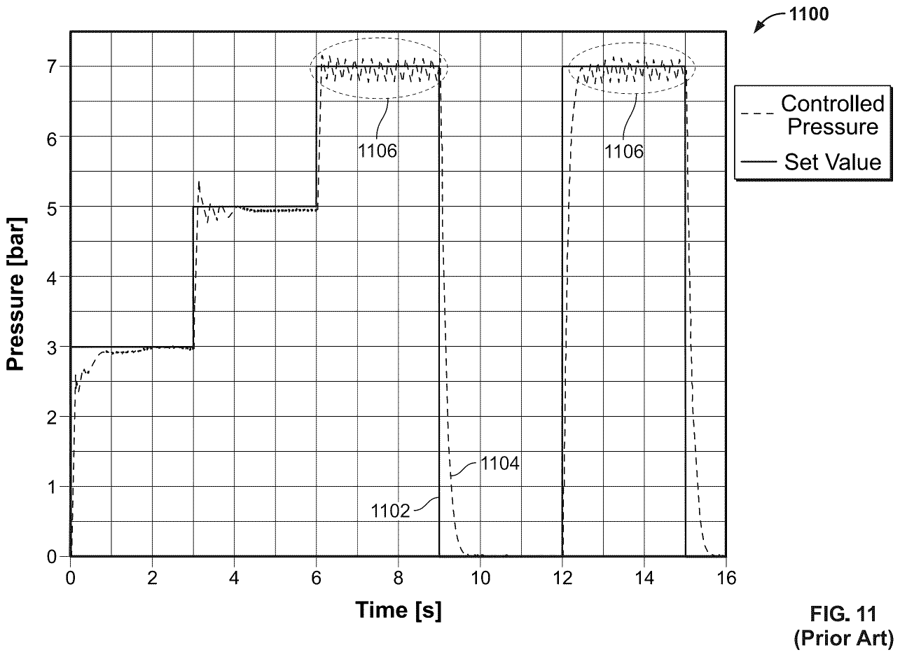

For example, FIG. 11 is a graph 1100 including pressure data associated with operation of the pneumatic valve cartridge 100 of FIG. 1 when implementing the valve seat 102 of FIGS. 1-10. The illustrated pressure data of FIG. 11 includes setpoint pressure data 1102 associated with a control system operatively coupled to (e.g., in electrical communication with) the proportional solenoid 114 of the pneumatic valve cartridge 100, and further includes controlled pressure data 1104 (e.g., actual measured pressure data) associated with the outlet port 118 of the pneumatic valve cartridge 100. As shown in FIG. 11, oscillations 1106 are persistently present in the controlled pressure data 1104 following rapid increases to the setpoint pressure data 1102. The persistence of such oscillations 1106 demonstrates an undesirable instability relative to the process of controlling the pressure of the airflow exiting the outlet port 118 of the pneumatic valve cartridge 100. There is accordingly a need to develop a high-precision valve seat for use with pneumatic valves and/or pneumatic valve cartridges that reduces and/or minimizes the oscillations 1106 shown in FIG. 11, thereby enhancing the ability for high-precision control (e.g., granular and/or fine control) of the airflow characteristics (e.g., pressure, rate, and/or volume) of the pneumatic valve and/or the pneumatic valve cartridge.

Unlike the known valve seat 102 described above in connection with FIGS. 1-10, example valve seats disclosed herein include a modified sealing surface having a plurality of indentations intentionally formed (e.g., machined) therein in an axial direction defined by the central axis 132 of the valve seat 102. In contrast to the interface surface 504 of the sealing surface 130 of the known valve seat 102, the interface surface of the modified sealing surface of the disclosed valve seats, which includes the aforementioned indentations, is not perfectly circular and/or perfectly annular in shape. The presence of the aforementioned indentations advantageously reduces the suddenness and/or rapidness by which the above-described airflow area 1002 located between the interface surface 504 of the sealing surface 130 of the known valve seat 102 of the pneumatic valve cartridge 100 and the sealing member 106 of the pneumatic valve cartridge 100 opens. In this regard, the rate at which the above-described airflow area 1002 opens as a function of the position of the plunger 104 relative to the valve seat 102 decreases due to the presence of the aforementioned indentations included in the sealing surface of the disclosed valve seats.

As a result of the airflow area 1002 opening more gradually (e.g., at a decreased rate) via the indentations formed in the modified sealing surface of the valve seat, the pressure, rate, and/or volume of air flowing to and/or exiting the outlet port 118 of the pneumatic valve cartridge 100 changes (e.g., increases) in a correspondingly more gradual manner, thereby making high-precision control (e.g., granular and/or fine control) of the airflow characteristics (e.g., pressure, rate, and/or volume) of the pneumatic valve cartridge 100 easier to achieve and/or maintain. The above-identified features as well as other advantageous features of example valve seats for enhancing precision control in pneumatic valves as disclosed herein are further described below in connection with the figures of the application.

As used herein, the term “indentation” means a recess and/or notch intentionally formed (e.g., intentionally machined) in a surrounding surface (e.g., such that the recess and/or notch extends inwardly from and/or relative to the surrounding surface). The term “indentation” does not encompass defects and/or deformations that are unintentionally formed (e.g., unintentionally machined) in a surface by virtue of manufacturing tolerances associated with the creation of the surface, and/or by virtue of wear on the surface stemming from use of a device that includes the surface.

As used herein in a mechanical context, the term “configured” means sized, shaped, arranged, structured, oriented, positioned, and/or located. For example, in the context of a first object configured to fit within a second object, the first object is sized, shaped, arranged, structured, oriented, positioned, and/or located to fit within the second object. As used herein in an electrical and/or computing context, the term “configured” means arranged, structured, and/or programmed. For example, in the context of a controller configured to perform a specified operation, the controller is arranged, structured, and/or programmed (e.g., based on machine-readable instructions) to perform the specified operation.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, the phrase “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

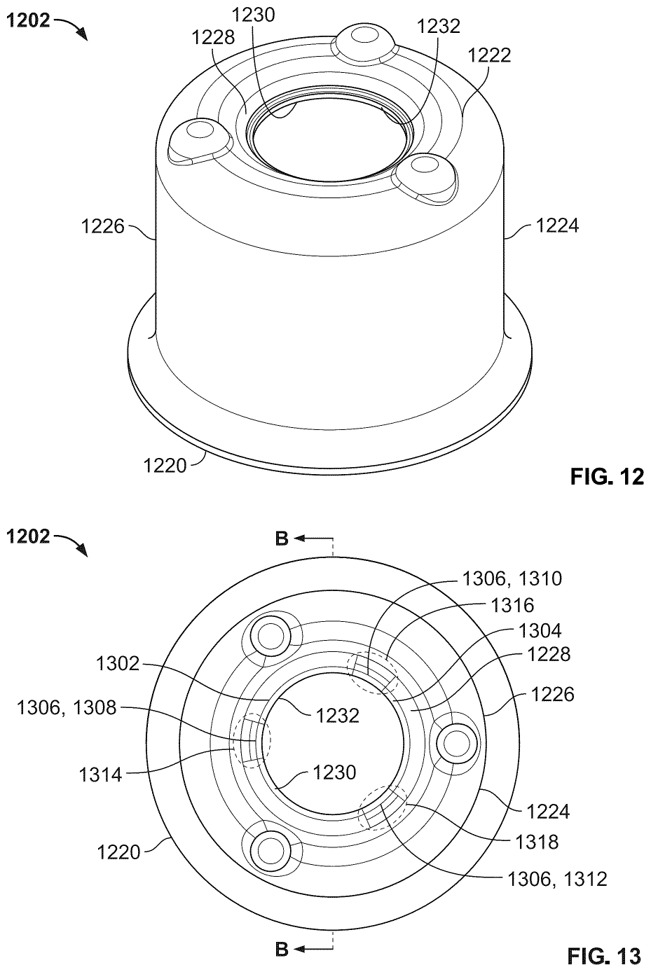

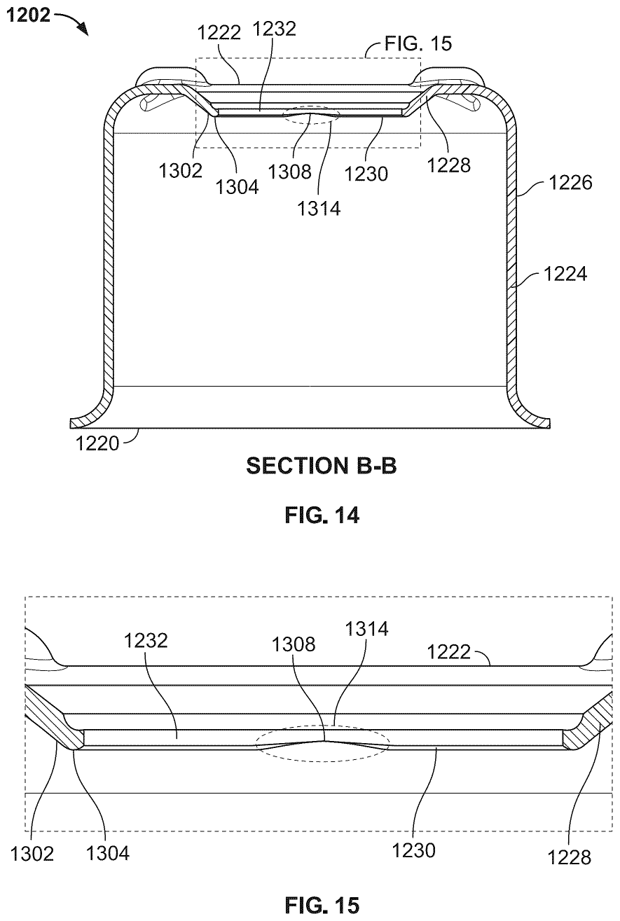

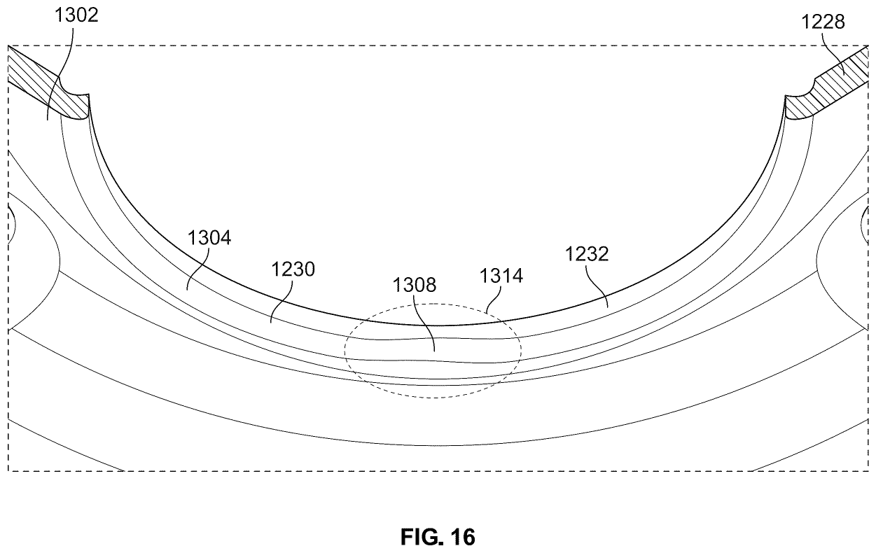

FIG. 12 is a perspective view of an example valve seat 1202 constructed in accordance with the teachings of this disclosure. FIG. 13 is a bottom view of the valve seat 1202 of FIG. 12. FIG. 14 is a cross-sectional view of the valve seat 1202 of FIGS. 12 and 13 taken along section B-B of FIG. 13. FIG. 15 is an enlarged view of a portion of FIG. 14. FIG. 16 is a rotated view of the portion of FIG. 14 shown in FIG. 15. The valve seat 1202 of FIGS. 12-16 is configured for use with the pneumatic valve cartridge 100 of FIG. 1 instead of the valve seat 102 of FIGS. 1-10 described above.

The valve seat 1202 of FIGS. 12-16 has many similarities to the valve seat 102 of FIGS. 1-10 described above. In this regard, the valve seat 1202 of FIG. 1202 is a deep-drawn, metallic (e.g., stainless steel) component to be included in the pneumatic valve cartridge 100. The valve seat 1202 includes a first end 1220 (e.g., a lower end) and a second end 1222 (e.g., an upper end) located opposite the first end 1220 of the valve seat 1202. The valve seat 1202 is configured to circumscribe the plunger 104 of the pneumatic valve cartridge 100. In this regard, the valve seat 1202 includes an annular sidewall 1224 having an outer portion 1226 extending from the first end 1220 of the valve seat 1202 to the second end 1222 of the valve seat 1202, and an inner portion 1228 located radially inward from the outer portion 1226 and extending downwardly from the second end 1222 (e.g., the upper end) of the valve seat 1202 toward the first end 1220 of the valve seat 1202. The inner portion 1228 of the annular sidewall 1224 of the valve seat 102 includes an annular rim that forms a sealing surface 1230 located between the first end 1220 and the second end 1222 of the valve seat 1202. The sealing surface 1230 of the valve seat 1202 is configured to contact and/or mate with the sealing member 106 of the pneumatic valve cartridge 100 when the plunger 104 of the pneumatic valve cartridge 100 is in the fully-closed position 200 relative to the valve seat 1202.

Much like the sealing surface 130 of the valve seat 102 of FIGS. 1-10, the sealing surface 1230 of the valve seat 1202 of FIGS. 12-16 includes an inner surface 1232 and an outer surface 1302 located opposite the inner surface 1232. The sealing surface 1230 further includes an interface surface 1304 extending between the inner surface 1232 and the outer surface 1302, with the interface surface 1304 being configured to contact and/or engage the sealing member 106 when the plunger 104 of the pneumatic valve cartridge 100 is in the fully-closed position 200 relative to the valve seat 102 of the pneumatic valve cartridge 100. Furthermore, much like the valve seat 102 of FIGS. 1-10, the valve seat 1202 of FIGS. 12-16 is a high-precision component manufactured according to dimensional specifications having very low tolerance ranges. As a result, the valve seat 1202 and, more specifically, the interface surface 1304 of the sealing surface 1230 of the valve seat 1202, has minimal unintended defects and/or unintended deformations.

Unlike the sealing surface 130 of the valve seat 102 of FIGS. 1-10, the sealing surface 1230 of the valve seat 1202 of FIGS. 12-16 includes a plurality of example indentations 1306 (e.g., recesses or notches) formed in (e.g., extending into) the sealing surface 1230 in an axial direction defined by the central axis 132 of the valve seat 1202. In the illustrated example of FIGS. 12-16, each of the indentations 1306 is axially formed in (e.g., extends axially into) the interface surface 1304 of the sealing surface 1230 of the valve seat 1202. As a result of the indentations 1306 formed in the interface surface 1304 of the sealing surface 1230, the interface surface 1304 of the sealing surface 1230 is not perfectly circular and/or perfectly annular. Unlike traditional defects and/or irregularities that are unintentionally, and often randomly, produced during a typical manufacturing and/or fabrication process of a valve seat, the indentations 1306 described herein are intentionally formed in the sealing surface 1230 of the valve seat 1202, and can be implemented in a repeatable manner from the manufacturing of one instance of the valve seat 1202 to the next.

In the illustrated example of FIGS. 12-16, the plurality of indentations 1306 includes three indentations 1306 (e.g., a first indentation 1308, a second indentation 1310, and a third indentation 1312). In other examples, the plurality of indentations 1306 can instead include a different number (e.g., 2, 4, 5, 6, etc.) of indentations 1306. In the illustrated example of FIGS. 12-16, respective ones of the three indentations 1306 are circumferentially spaced apart from one another about the interface surface 1304 of the sealing surface 1230 of the valve seat 1202, with the spacing between the respective ones of the three indentations 1306 being approximately equal. In this regard, the first indentation 1308, the second indentation 1310, and the third indentation 1312 of the sealing surface 1230 are respectively located at corresponding ones of a first circumferential position 1314, a second circumferential position 1316, and a third circumferential position 1318 along the interface surface 1304 of the sealing surface 1230, with respective ones of the first, second, and third circumferential positions 1314, 1316, 1318 being spaced apart by approximately one-hundred twenty degrees (120°). In other examples, the circumferential spacing of the respective ones of the indentations 1306 about the interface surface 1304 of the sealing surface 1230 can differ relative to that shown in FIG. 13 and described above.

In the illustrated example of FIGS. 12-16, each of the indentations 1306 has a rounded, concave shape resembling the rounded portion of a quarter sphere. In other examples, one or more of the indentations can instead have a different shape (e.g., a triangular or pyramidal shape, a rectangular or box-like shape, etc.). In the illustrated example of FIGS. 12-16, each of the indentations 1306 occupies a sector that accounts for approximately twelve percent (12%) of a circumference defined by the interface surface 1304 of the sealing surface 1230. In other examples, one or more of the indentations 1306 can instead occupy a sector that accounts for a different percentage (e.g., as low as two percent (2%), or as high as twenty-five percent (25%)) of the circumference defined by the interface surface 1304 of the sealing surface 1230.

When the plunger 104 of the pneumatic valve cartridge 100 is in the fully-closed position 200 relative to the valve seat 1202 of the pneumatic valve cartridge 100, the high-precision geometry of the sealing surface 1230 of the valve seat 1202 facilitates the formation of a reliable, air-tight seal between the interface surface 1304 of the sealing surface 1230 of the valve seat 1202 and the sealing member 106 that is coupled to the plunger 104. Notably, the indentations 1306 formed in the interface surface 1304 of the sealing surface 1230 of the valve seat 1202 do not result in the leakage of air when the plunger 104 is in the fully-closed position 200 relative to the valve seat 1202, and do not otherwise impede or reduce the reliability of the air-tight seal that is formed between the interface surface 1304 of the sealing surface 1230 of the valve seat 1202 and the sealing member 106 that is coupled to the plunger 104 when the plunger 104 is in the fully-closed position 200 relative to the valve seat 1202.

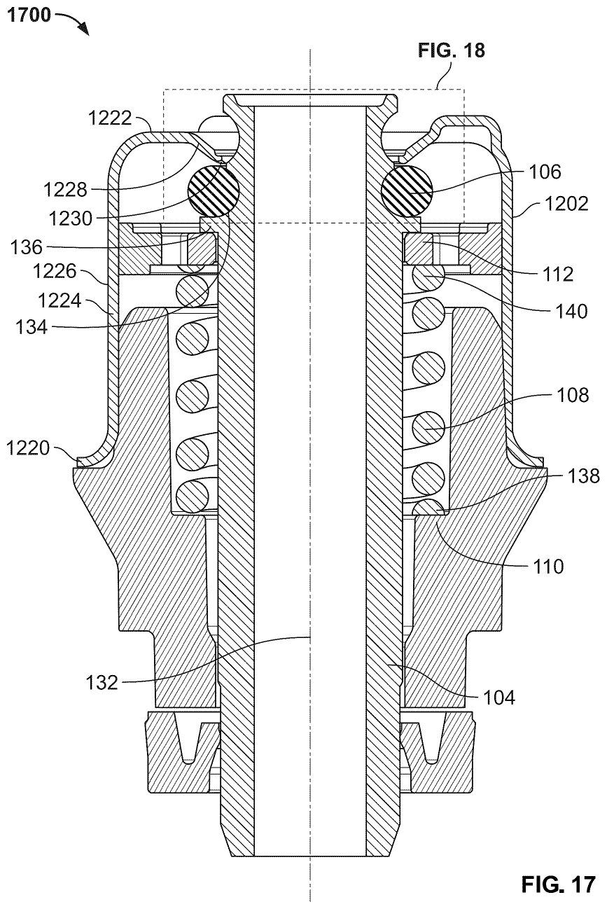

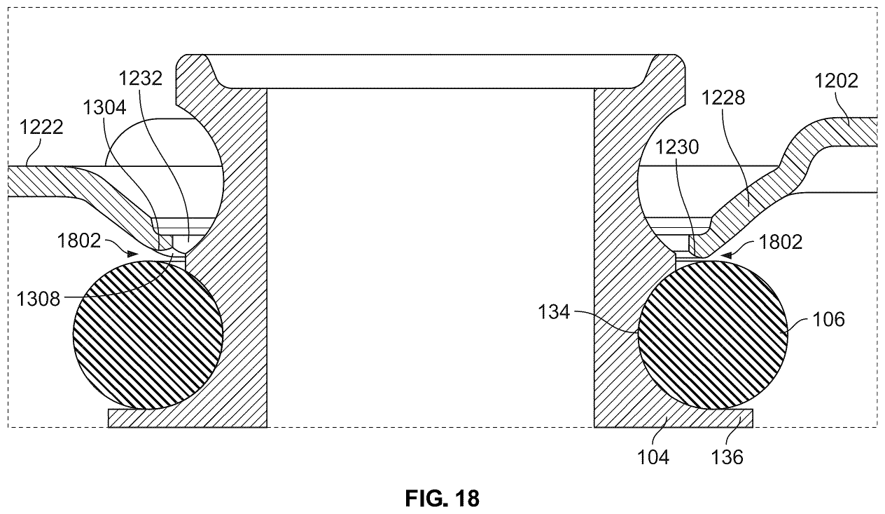

FIG. 17 is a cross-sectional view illustrating the plunger 104 of FIGS. 1-3, 9, and 10 in a partially-open position 1700 relative to the valve seat 1202 of FIGS. 12-16. FIG. 18 is an enlarged view of a portion of FIG. 17. As the plunger 104 of the pneumatic valve cartridge 100 moves from the fully-closed position 200 shown in FIG. 2 into the partially-open position 1700 shown in FIGS. 17 and 18, the indentations 1306 formed in the interface surface 1304 of the sealing surface 1230 of the valve seat 1202 provide additional flow channels by which air can flow between the valve seat 1202 and the sealing member 106 that is coupled to the plunger 104. The additional flow channels provided by the indentations 1306 of the sealing surface 1230 of the valve seat 1202 are configured to reduce oscillations associated with a controlled pressure at the outlet port 118 of the pneumatic valve cartridge 100 when the plunger 104 of the pneumatic valve cartridge 100 is transitioning from the fully-closed position 200 shown in FIG. 2 into the partially-open position 1700 shown in FIGS. 17 and 18.

As discussed above in connection with FIGS. 9 and 10, as the plunger 104 of the pneumatic valve cartridge 100 moves from the fully-closed position 200 shown in FIG. 2 into the partially-open position 900 shown in FIGS. 9 and 10, the perfectly-circular and/or perfectly-annular shape of the interface surface 504 of the sealing surface 130 of the valve seat 102 of FIGS. 1-10 causes the sudden and/or rapid opening of the relatively large, perfectly-annular airflow area 1002 located between the interface surface 504 of the sealing surface 130 of the valve seat 102 of the pneumatic valve cartridge 100 and the sealing member 106 of the pneumatic valve cartridge 100. By contrast, as the plunger 104 of the pneumatic valve cartridge 100 moves from the fully-closed position 200 shown in FIG. 2 into the partially-open position 1700 shown in FIGS. 17 and 18, the indentations 1306 axially formed in the interface surface 1304 of the sealing surface 1230 of the valve seat 1202 of FIGS. 12-18 cause a substantially less sudden and/or less rapid opening of an airflow area 1802 that, while of a generally-annular shape, is not perfectly circular and/or perfectly annular in shape. The reduced suddenness by which the airflow area 1802 is opened as a result of the indentations 1306 axially formed in the interface surface 1304 of the sealing surface 1230 enables, improves, and/or otherwise enhances the capability for high-precision control (e.g., granular and/or fine control) of the airflow characteristics (e.g., pressure, rate, and/or volume) associated with air flowing to and/or exiting the outlet port 118 of the pneumatic valve cartridge 100.

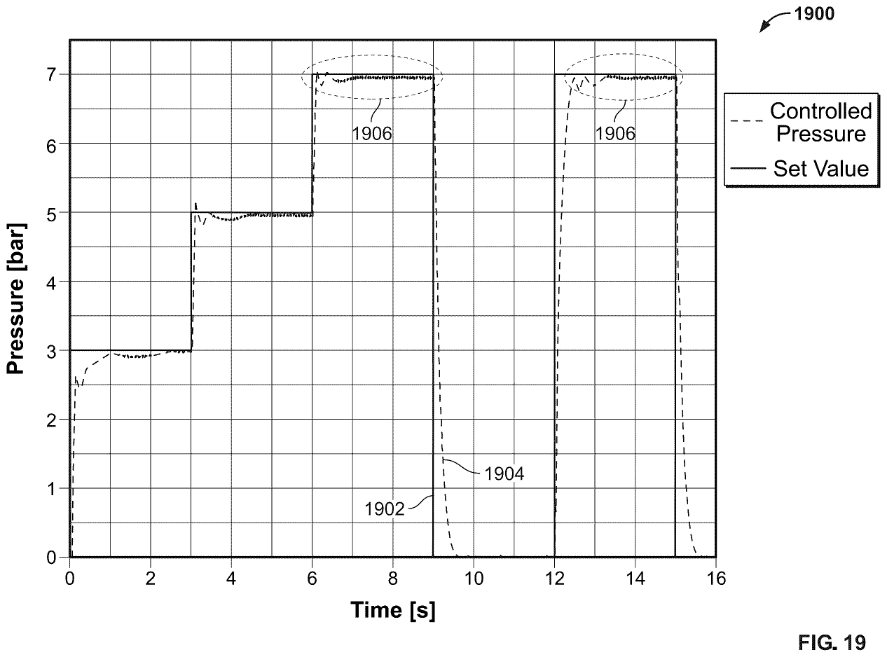

For example, FIG. 19 is a graph 1900 including pressure data associated with operation of the pneumatic valve cartridge 100 of FIG. 1 when implementing the valve seat 1202 of FIGS. 12-18 in lieu of the valve seat 102 of FIGS. 1-10. The illustrated pressure data of FIG. 19 includes setpoint pressure data 1902 associated with a control system operatively coupled to (e.g., in electrical communication with) the proportional solenoid 114 of the pneumatic valve cartridge 100, and further includes controlled pressure data 1904 (e.g., actual measured pressure data) associated with the outlet port 118 of the pneumatic valve cartridge 100. As shown in FIG. 19, oscillations 1906 that are present in the controlled pressure data 1904 following rapid increases to the setpoint pressure data 1902 are reduced both in magnitude and in duration relative to the oscillations 1106 that are persistently present in the controlled pressure data 1104 described above in connection with FIG. 11 and the valve seat 102 of FIGS. 1-10. The illustrated reduction in the magnitude and duration of the oscillations 1906 associated with the valve seat 1202 of FIGS. 12-18 relative to the magnitude and duration of the oscillations 1106 associated with the valve seat 102 of FIGS. 1-10 is attributed entirely to the presence of the above-described indentations 1306 formed in the interface surface 1304 of the sealing surface 1230 of the valve seat 1202 of FIGS. 12-18. The illustrated reduction in the magnitude and duration of the oscillations 1906 associated with the valve seat 1202 of FIGS. 12-18 relative to the magnitude and duration of the oscillations 1106 associated with the valve seat 102 of FIGS. 1-10 demonstrates a significant improvement in the stability associated with the process of controlling the pressure of the airflow exiting the outlet port 118 of the pneumatic valve cartridge 100 when the valve seat 1202 of FIGS. 12-18 is implemented in place of the valve seat 102 of FIGS. 1-10. This improvement in stability enables, improves, and/or otherwise enhances the capability for high-precision control (e.g., granular and/or fine control) of the airflow characteristics (e.g., pressure, rate, and/or volume) associated with air flowing to and/or exiting the outlet port 118 of the pneumatic valve cartridge 100.

Although the valve seat 1202 of FIGS. 12-18 is described above primarily in the context of being a component of the pneumatic valve cartridge 100, it is to be understood that the valve seat 1202 can alternatively be configured for use with any pneumatic valve cartridge and/or any pneumatic valve of any size and/or any shape. In this regard, the term “pneumatic valve” as used throughout the specification and claims of the instant application is intended to broadly encompass not only pneumatic valve cartridges, but also pneumatic valves having a valve body that is configured to receive, house, and/or carry components such as the valve seat 1202, the plunger 102, the sealing member 106, the spring 108, the spring seat 110, the spring retainer 112, and/or the proportional solenoid 114 described above.

Although the valve seat 1202 of FIGS. 12-18 is described above as being a deep drawn valve seat, it is to be understood that the valve seat 1202 can alternatively be fabricated, structured and/or otherwise configured via a different manufacturing and/or forming process resulting in a valve seat of any size and/or any shape. Similarly, although the valve seat 1202 of FIGS. 12-18 is described above as being a metallic valve seat, it is to be understood that the valve seat 1202 can alternatively be fabricated from a non-metallic material.

Although the enhanced precision pressure control benefits described above are attributed to the inclusion of the indentations 1306 formed in the sealing surface 1230 of the valve seat 1202 of FIGS. 12-18, it is possible that such benefits can alternatively or additionally be achieved by forming similar indentations in a sealing surface of a sealing member (e.g., the sealing member 106) that interfaces with the sealing surface 1230 of the valve seat 1202. For example, indentations that are similar in size and/or shape to the indentations 1306 formed in the sealing surface 1230 of the valve seat 1202 could instead be formed in a sealing surface of a vulcanized rubber sealing member (e.g., the sealing member 106) that is coupled to the plunger 104 of the above-described valve cartridge 100.

From the foregoing, it will be appreciated that valve seats for enhancing precision control in pneumatic valves are disclosed herein. Example disclosed valve seats include a sealing surface having a plurality of indentations intentionally formed (e.g., machined) therein in an axial direction defined by a central axis of the valve seat. As a result of such indentations, the sealing surface of the disclosed valve seats is not perfectly circular and/or perfectly annular in shape. The presence of the aforementioned indentations advantageously reduces the suddenness and/or rapidness by which an airflow area located between the interface surface of the sealing surface of a valve seat of a pneumatic valve cartridge and a sealing member of the pneumatic valve cartridge opens. In this regard, the rate at which such an airflow area opens as a function of the position of a plunger of the pneumatic valve cartridge relative to the valve seat of the pneumatic valve cartridge decreases due to the presence of the aforementioned indentations included in the sealing surface of the disclosed valve seats. As a result of the airflow area opening more gradually (e.g., at a decreased rate) via the indentations formed in the sealing surface of the disclosed valve seats, the pressure, rate, and/or volume of air flowing to and/or exiting an outlet port of the pneumatic valve cartridge changes (e.g., increases) in a correspondingly more gradual manner, thereby making high-precision control (e.g., granular and/or fine control) of the airflow characteristics (e.g., pressure, rate, and/or volume) of the pneumatic valve cartridge easier to achieve and/or maintain.

The following paragraphs provide various examples of the examples disclosed herein.

Example 1 includes a valve seat for use with a pneumatic valve. The valve seat of Example 1 comprises a central axis and a sealing surface. In Example 1, the sealing surface includes a plurality of indentations extending in an axial direction defined by the central axis.

Example 2 includes the valve seat of Example 1, wherein the sealing surface includes an inner surface, an outer surface located opposite the inner surface, and an interface surface extending between the inner surface and the outer surface. In Example 2, respective ones of the indentations are formed in the interface surface.

Example 3 includes the valve seat of Example 1, wherein the indentations are configured to enhance precision control of the pneumatic valve by providing additional flow channels by which air can flow past the valve seat when a plunger of the pneumatic valve is transitioning from a fully-closed position relative to the valve seat into a partially-open position relative to the valve seat.

Example 4 includes the valve seat of Example 3, wherein the additional flow channels are configured to reduce oscillations associated with a controlled pressure at an outlet port of the pneumatic valve when the plunger is transitioning from the fully-closed position into the partially-open position.

Example 5 includes the valve seat of Example 1, wherein the plurality of indentations includes three indentations.

Example 6 includes the valve seat of Example 5, wherein respective ones of the three indentations are circumferentially spaced apart from one another about the sealing surface.

Example 7 includes the valve seat of Example 1, wherein the valve seat further comprises a first end, a second end, and an annular sidewall. In Example 7, the second end is located opposite the first end. In Example 7, the annular sidewall includes an outer portion and an inner portion. In Example 7, the outer portion extends from the first end to the second end, and the inner portion extends from the second end toward the first end. In Example 7, the inner portion is located radially inward relative to the outer portion. In Example 7, the inner portion includes the sealing surface.

Example 8 includes the valve seat of Example 7, wherein the sealing surface is located between the first end and the second end.

Example 9 includes the valve seat of Example 7, wherein the valve seat is metallic.

Example 10 includes the valve seat of Example 7, wherein the valve seat is a deep drawn valve seat.

Example 11 includes a pneumatic valve cartridge. The pneumatic valve cartridge of Example 11 comprises a valve seat. In Example 11, the valve seat includes a central axis and a sealing surface. In Example 11, the sealing surface includes a plurality of indentations extending in an axial direction defined by the central axis. The pneumatic valve cartridge of Example 11 further comprises a plunger movable relative to the valve seat along the central axis between a fully-closed position and a fully-open position. The pneumatic valve cartridge of Example 11 further comprises a sealing member coupled to the plunger. In Example 11, the sealing member is configured to form an air-tight seal with the sealing surface when the plunger is in the fully-closed position. The pneumatic valve cartridge of Example 11 further comprises a proportional solenoid configured to move the plunger relative to the valve seat.

Example 12 includes the pneumatic valve cartridge of Example 11, wherein the sealing surface includes an inner surface, an outer surface located opposite the inner surface, and an interface surface extending between the inner surface and the outer surface. In Example 12, respective ones of the indentations are formed in the interface surface.

Example 13 includes the pneumatic valve cartridge of Example 11, wherein the indentations are configured to enhance precision control of the pneumatic valve cartridge by providing additional flow channels by which air can flow past the valve seat when the plunger is transitioning from the fully-closed position into a partially-open position relative to the valve seat.

Example 14 includes the pneumatic valve cartridge of Example 13, wherein the additional flow channels are configured to reduce oscillations associated with a controlled pressure at an outlet port of the pneumatic valve cartridge when the plunger is transitioning from the fully-closed position into the partially-open position.

Example 15 includes the pneumatic valve cartridge of Example 11, wherein the plurality of indentations includes three indentations.

Example 16 includes the pneumatic valve cartridge of Example 15, wherein respective ones of the three indentations are circumferentially spaced apart from one another about the sealing surface.

Example 17 includes the pneumatic valve cartridge of Example 11, wherein the valve seat further includes a first end, a second end, and an annular sidewall. In Example 17, the second end is located opposite the first end. In Example 17, the annular sidewall includes an outer portion and an inner portion. In Example 17, the outer portion extends from the first end to the second end, and the inner portion extends from the second end toward the first end. In Example 17, the inner portion is located radially inward relative to the outer portion. In Example 17, the inner portion includes the sealing surface.

Example 18 includes the pneumatic valve cartridge of Example 17, wherein the sealing surface is located between the first end and the second end.

Example 19 includes the pneumatic valve cartridge of Example 17, wherein the valve seat is metallic.

Example 20 includes the pneumatic valve cartridge of Example 17, wherein the valve seat is a deep drawn valve seat.

Although certain example methods, apparatus, and articles of manufacture have been disclosed herein, the scope of coverage of this patent is not limited thereto. On the contrary, this patent covers all methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A valve seat for use with a pneumatic valve, the valve seat comprising:
a central axis; and
a sealing surface including a plurality of indentations extending in an axial direction defined by the central axis.

2. The valve seat of claim 1, wherein the sealing surface includes an inner surface, an outer surface located opposite the inner surface, and an interface surface extending between the inner surface and the outer surface, wherein respective ones of the indentations are formed in the interface surface.

3. The valve seat of claim 1, wherein the indentations are configured to enhance precision control of the pneumatic valve by providing additional flow channels by which air can flow past the valve seat when a plunger of the pneumatic valve is transitioning from a fully-closed position relative to the valve seat into a partially-open position relative to the valve seat.

4. The valve seat of claim 3, wherein the additional flow channels are configured to reduce oscillations associated with a controlled pressure at an outlet port of the pneumatic valve when the plunger is transitioning from the fully-closed position into the partially-open position.

5. The valve seat of claim 1, wherein the plurality of indentations includes three indentations.

6. The valve seat of claim 5, wherein respective ones of the three indentations are circumferentially spaced apart from one another about the sealing surface.

7. The valve seat of claim 1, further comprising:
a first end;
a second end located opposite the first end; and
an annular sidewall including an outer portion and an inner portion, the outer portion extending from the first end to the second end, the inner portion extending from the second end toward the first end, the inner portion located radially inward relative to the outer portion, the inner portion including the sealing surface.

8. The valve seat of claim 7, wherein the sealing surface is located between the first end and the second end.

9. The valve seat of claim 7, wherein the valve seat is metallic.

10. The valve seat of claim 7, wherein the valve seat is a deep drawn valve seat.

11. A pneumatic valve cartridge, comprising:
a valve seat including:
a central axis; and
a sealing surface including a plurality of indentations extending in an axial direction defined by the central axis;
a plunger movable relative to the valve seat along the central axis between a fully-closed position and a fully-open position;
a sealing member coupled to the plunger, the sealing member configured to form an air-tight seal with the sealing surface when the plunger is in the fully-closed position; and
a proportional solenoid configured to move the plunger relative to the valve seat.

12. The pneumatic valve cartridge of claim 11, wherein the sealing surface includes an inner surface, an outer surface located opposite the inner surface, and an interface surface extending between the inner surface and the outer surface, wherein respective ones of the indentations are formed in the interface surface.

13. The pneumatic valve cartridge of claim 11, wherein the indentations are configured to enhance precision control of the pneumatic valve cartridge by providing additional flow channels by which air can flow past the valve seat when the plunger is transitioning from the fully-closed position into a partially-open position relative to the valve seat.

14. The pneumatic valve cartridge of claim 13, wherein the additional flow channels are configured to reduce oscillations associated with a controlled pressure at an outlet port of the pneumatic valve cartridge when the plunger is transitioning from the fully-closed position into the partially-open position.

15. The pneumatic valve cartridge of claim 11, wherein the plurality of indentations includes three indentations.

16. The pneumatic valve cartridge of claim 15, wherein respective ones of the three indentations are circumferentially spaced apart from one another about the sealing surface.

17. The pneumatic valve cartridge of claim 11, wherein the valve seat further includes:
a first end;
a second end located opposite the first end; and
an annular sidewall including an outer portion and an inner portion, the outer portion extending from the first end to the second end, the inner portion extending from the second end toward the first end, the inner portion located radially inward relative to the outer portion, the inner portion including the sealing surface.

18. The pneumatic valve cartridge of claim 17, wherein the sealing surface is located between the first end and the second end.

19. The pneumatic valve cartridge of claim 17, wherein the valve seat is metallic.

20. The pneumatic valve cartridge of claim 17, wherein the valve seat is a deep drawn valve seat.
